(19) United States
(12) Patent Application Publication
(10) Pub. No.: US 2015/0189132 A1
(43) Pub. Date: Jul. 2, 2015

(54) Article of clothing

(71) Applicant: Matt Sandy, Elmsford, NY (US)

(72) Inventor: Matt Sandy, Elmsford, NY (US)

(21) Appl. No.: 13/999,005

(22) Filed: Jan. 2, 2014

(51) Int. Cl. H04N 5/225

(52) U.S. Cl. CPC H04N 5/2252

(57) ABSTRACT

An article of clothing has at least one element of clothing wearable by a user, and a recording camera associated with the element of clothing and carrying out a recording process while being associated with the element of clothing.

### BACKGROUND OF THE INVENTION

The present invention relates to article of clothing wearable by users on various occasions.

Articles of clothing are widely known and worn by users for the major purposes of covering parts of a human body. It is believed however that it would be advisable to construct articles of clothing in such a way that, in addition to their main function of covering parts of human body, they can also perform other different function which are not related to the wearing function only, but carry out other actions which can be important in lives of people.

### SUMMARY OF THE INVENTION

Accordingly, it is an object of the present invention to provide an article of clothing which is a further improvement of the existing articles of clothing.

In keeping with these objects and with others which will become apparent hereinafter one feature of the present invention resides, briefly stated, in an article of clothing which has at least one element of clothing, and a recording camera associated with said element of clothing and carrying out a recording process while being associated with said element of clothing.

In accordance with a further feature of the present invention, the recording camera is constructed to be arranged on an outer surface of the element of clothing, and at least one or a plurality of cover pieces can be provided with are constructed to cover a front side of the camera, leaving unobstructed only an objective or a recording window of the camera, wherein the cover pieces can have different front faces which are substantially compatible with a front face of the element of clothing.

In accordance with another feature of the present invention, the article of closing is provided with at least one receptacle, in which the recording camera is received so that its objective remains unobstructed.

In accordance with a further feature of the present invention the recording camera has a plurality of sensing elements locatable on a plurality of sides of the element of clothing and carrying out the recording process on different sides of the element of clothing or over an area of 360 degrees.

Still a further feature of the present invention is that the recording camera is constructed to carry out an automated photography, for example, from 1 to 120 second delay with and without audio recording, as well as a video recording to record during a certain time or over a certain number of periods. These functions can be instructed by the software applications on a wireless remotely operating device, for example on a cellphone, a smartphone and the like.

A further feature of the present invention resides in that the recording camera is provided with a motion detecting element and is activated for recording when the motion detecting element detects a motion in a vicinity of the camera and therefore in the vicinity of a person who wears the article of clothing

Still a further feature of the present invention is that the recording camera is constructed to make a plurality of photos and has an activating member provided on the camera when the latter is supported by the element of clothing and activated by a user, to make the photos.

A further feature of the present invention is that the camera is constructed as a wirelessly operated camera, and a remotely operating device is provided for operating the wireless camera.

In accordance with a further feature of the present invention, the wireless camera and/or the remotely operating device are constructed so that they can store video images and/or audio messages recorded by the wireless camera.

In accordance with another feature of the present invention, the recording camera can be constructed to record photos during the video recording mode enabled by a wireless control device, for example by the software applications of a smartphone and the like.

The novel features of the present invention are set forth in particular in the appended claims.

The invention itself, however, both as to its construction and its manner of operation will be best understood from the following description of the preferred embodiments, which is accompanied by the following drawings.

### BRIEF DESCRIPTION OF THE DRAWING

FIG. 1 of the drawings is a view showing an article of clothing according to the invention, with an element of clothing, a recording camera, and a remotely operating control device;

FIG. 2 is a perspective view of the recording camera in accordance with the present invention;

FIGS. 3 and 4 are a front view and a side view of the article of clothing in accordance with a further embodiment of the invention;

FIG. 5 is a view showing the recording camera with a cover plate in accordance with the invention;

FIG. 6 is a view showing a further embodiment of the inventive article of clothing; and

FIG. 7 is a view showing another embodiment of the article of clothing in accordance with the invention.

### DESCRIPTION OF THE PREFERRED EMBODIMENTS

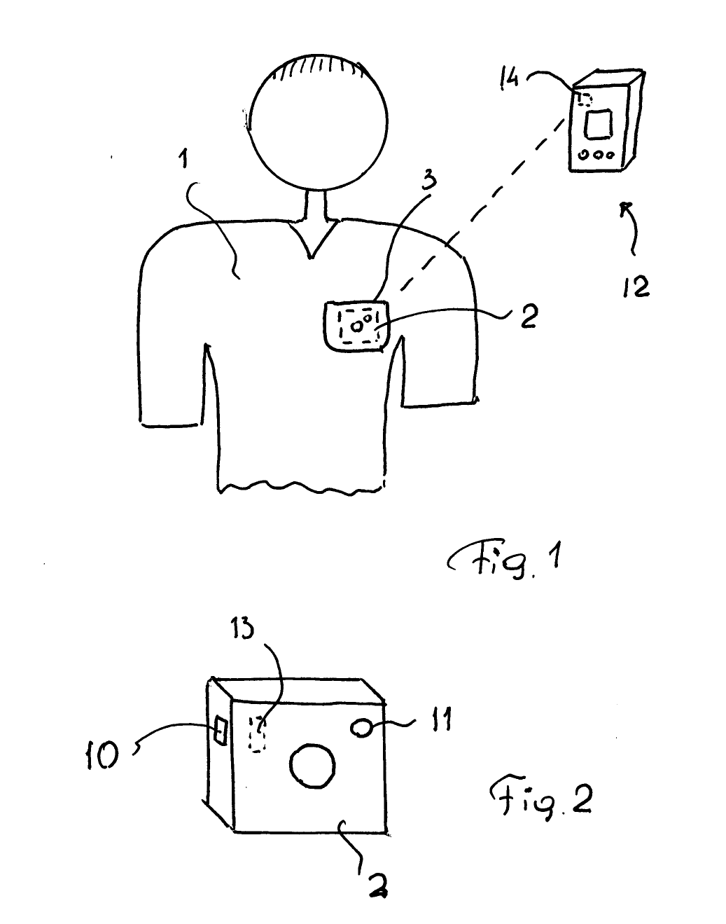

An article of clothing in accordance with the present invention includes an element of clothing which is identified as a whole with reference numeral 1. The article of clothing further has a recording camera which is identified as a whole with reference numeral 2 and is associated with the element of clothing 1. The recording camera 2 which is shown in FIG. 2 is constructed to carry a recording process while being associated with the element of clothing 1.

FIG. 1 shows that the element of clothing 1 can be provided with at least one receptacle 3, for example in form of a pocket, in which the recording camera 2 is received. In order to allow the recording process the objective of the camera remains unobstructed by the pocket 3, for example by providing a hole in the pocket 3 in the area of the objective of the recording camera 2. A hole can be also made in the area of control button of the recording camera 2 to enable a user to control the recording process.

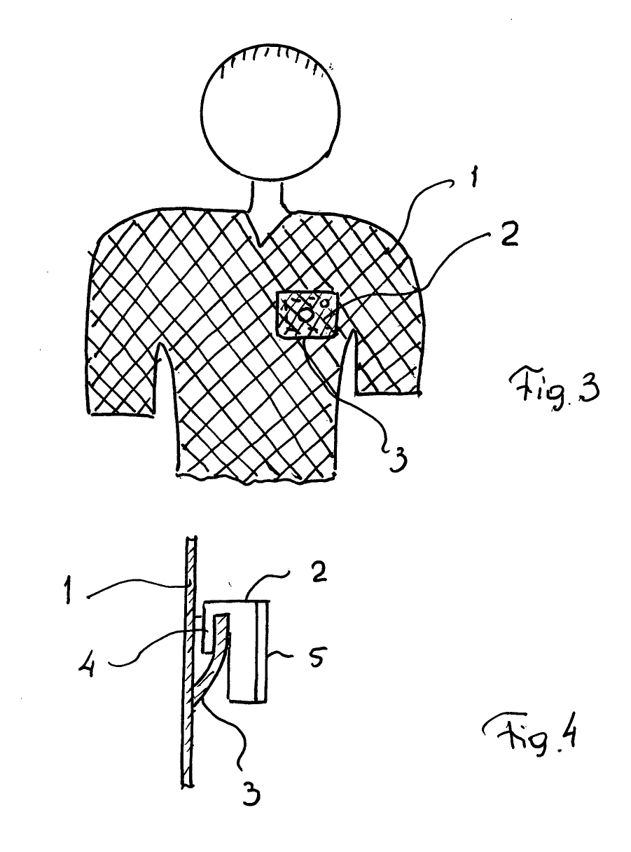

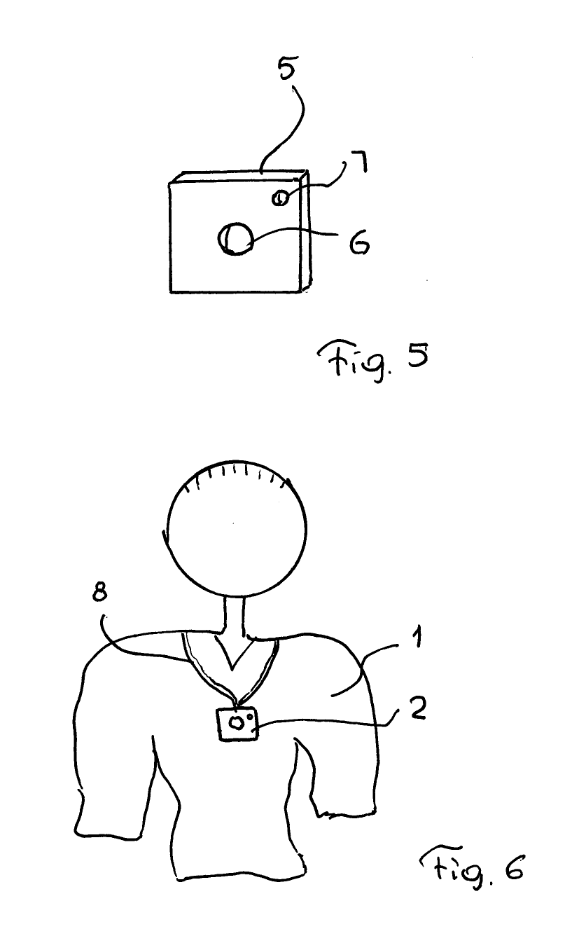

In accordance with another feature of the present invention shown in FIGS. 3-5 the recording camera 2 can be arranged on an outer surface of the element of clothing 1, for example being connected to the latter, in particular to the pocket 3, by a clip 4, or being suspended on a necklace 8, etc. In order to prevent undesirable recognition of the recording camera 2 on the element of clothing 1, a plurality of cover pieces 5 can be provided, each having a different face design corresponding to the face design of the element of clothing 1. As an example, it can be seen from FIGS. 3 and 5 that both the face of the element of clothing 1 and of the cover piece 5 have a square design. Each cover piece 5 has an opening 6 for the objective of the recording camera and an opening 7 for its control button.

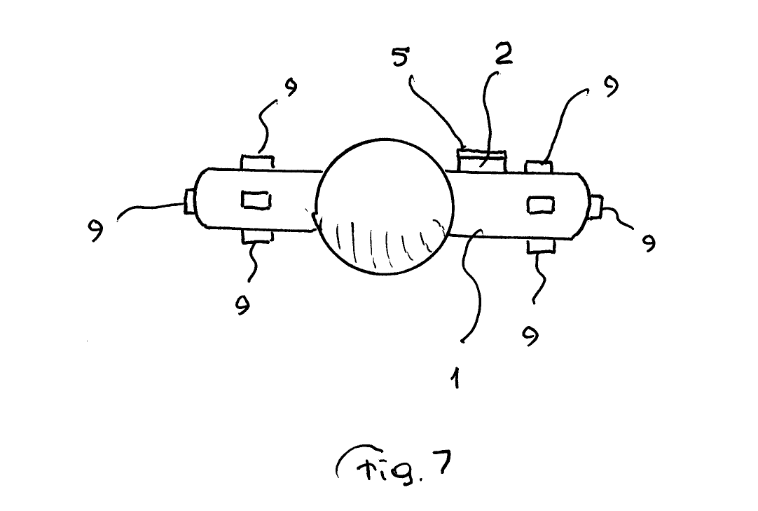

It is shown in FIG. 6 that the recording camera 2 can be suspended on a necklace or string 8 on the front surface of the element of clothing 1, and also can be covered by the cover plate 5 with a design which matches the design of the element of clothing 1

As shown in FIG. 7 the recording camera 2 can be operatively connected, for example wirelessly, with sensors 9 which can be arranged on the element of clothing 1 on its front, rear, left, right sides so as to receive signals from the sensors 9 and to carry out a panoramic recording on several sides, even over 360 degrees around the user. The sensors 9 can be arranged additionally even on top and on the bottom of the element of clothing 1 to carry a three-dimensional recording around the user.

The recording camera 2 can be constructed to carry out different types of a video recording with or without an audio recording. In particular it can carry out an automated photography, for example from 1 to 120 seconds delay with or without audio recording. It can also carry out a video recording to record during a certain time, or to record over a certain number of periods.

As shown in FIG. 2 the recording camera 2 can be provided with a motion detecting element 10. It is constructed so that it detects a motion in the vicinity of the camera and therefore of the user, and consequently activate the recording camera 2 automatically, just in response to the motion detection.

The recording camera 2 has a control or activating element 11 formed for example as a control button, with which the user operates to carry out the above mentioned recording processes carried out by the camera. The control or activating element 11 can also activate the recording camera to carry out making a plurality of photos.

While the recording process can be selected and activated directly on the recording camera 2 by the control or activating element 11, in accordance with another advantageous feature of the present invention the recording camera 2 can be constructed as wirelessly operating recording camera, and a remotely operating control device 12 can be provided for remotely operating the recording camera for carrying out by the latter all desired recording processes. The remotely operating control device 12 can be formed as any correspondingly constructed electronic device, such as a remote controller, a cellular telephone, etc.

In accordance with a still important and highly advantageous feature of the present invention the recording camera 2 and/or the remotely controlling device 12 can be constructed as can operated so that the recorded video images and/or audio messages can be stored in a memory 13 of the recording camera 2, or can be transferred to the remotely operating control device 11 and stored in a memory 14 of the latter, or both for a subsequent retrieval, for example for viewing, copying out, etc.

Furthermore, the recording camera 2 can be constructed so that it simultaneously carries out a photography recording during a video recording, and it can be remotely controlled by the remotely controlling device wirelessly, to store, exchange and reproduce after the storing the photo and video images recorded by the recording camera 2.

The invention is not limited to the details shown since various modifications and structural changes are possible without departing in any way from the spirit of the invention.

What is desired to be protected by Letters Patent is set forth in particular in the appended claims.

1. An article of clothing, comprising
at least one element of clothing wearable by a user; and
a recording camera associated with said element of clothing and constructed for carrying out a recording process while being associated with said element of clothing.

2. An article of clothing as defined in claim 1, wherein said element of clothing has at least one receptacle in which said recording camera is receivable with a possibility of carrying out the recording process while being located in said receptacle.

3. An article of clothing as defined in claim 1, wherein said recording camera is arranged on a surface of said element of clothing, further comprising a plurality of cover pieces constructed to cover a front face of said recording camera and having a front face with a design corresponding to a design of the surface of said element of clothing.

4. An article of clothing as defined in claim 1, wherein said recording camera has a plurality of sensing elements arrangeable on various sides of said element of clothing and constructed to carry out recording on said sides to provide a panoramic and/or three-dimensional recording.

5. An article of clothing as defined in claim 1, wherein said camera is constructed to carry out recordings selected from the group consisting of an audio recording, a video recording, an automated photography with or without audio recording, a video recording to record over a certain time or over a number of periods, to make a plurality of photos, and combinations thereof.

6. An article of clothing as defined in claim 2, wherein said camera is constructed to carry out recordings selected from the group consisting of an audio recording, a video recording, an automated photography with or without audio recording, a video recording to record over a certain time or over a number of periods, to make a plurality of photos, and combinations thereof.

7. An article of clothing as defined in claim 3, wherein said camera is constructed to carry out recordings selected from the group consisting of an audio recording, a video recording, an automated photography with or without audio recording, a video recording to record over a certain time or over a number of periods, to make a plurality of photos, and combinations thereof.

8. An article of clothing as defined in claim 1, wherein said camera is constructed to simultaneously carry out photography recording during video recording, and wherein said recording camera is remotely controllable with a wireless controlling device to store, exchange and reproduce after storing photo and video images recorded by said recording camera.

9. An article of clothing as defined in claim 2, wherein said camera is constructed to simultaneously carry out photography recording during video recording, and wherein said recording camera is remotely controllable with a wireless controlling device to store, exchange and reproduce after storing photo and video images recorded by said recording camera.

10. An article of clothing as defined in claim 3, wherein said camera is constructed to simultaneously carry out photography recording during video recording, and wherein said recording camera is remotely controllable with a wireless controlling device to store, exchange and reproduce after storing photo and video images recorded by said recording camera.

11. An article of clothing as defined in claim 1, wherein said recording camera is constructed as a wirelessly operated recording camera, further comprising a remotely operating controlling device which is constructed to remotely control said recording camera to enable the latter to carry out the recording process, wherein said recording camera and/or said remotely operating control device are constructed to store, to exchange and to reproduce after storing video images and/or audio messages recorded by said recording camera.

12. An article of clothing as defined in claim 7, wherein said recording camera is constructed as a wirelessly operated recording camera, further comprising a remotely operating controlling device which is constructed to remotely control said recording camera to enable the latter to carry out the recording process.

13. An article of clothing as defined in claim 12, wherein said recording camera and/or said remotely operating control device are constructed to store, to exchange and to reproduce after storing video images and/or audio messages recorded by said recording camera.

14. An article of clothing as defined in claim 4, wherein said recording camera is constructed as a wirelessly operated recording camera, further comprising a remotely operating controlling device which is constructed to remotely control said recording camera to enable the latter to carry out the recording process, and/or said remotely operating controlling device is constructed to store, to exchange and to reproduce after storing photo and/or video images and/or audio messages recorded by said camera.

15. An article of clothing as defined in claim 5, wherein said recording camera is constructed as a wirelessly operated recording camera, further comprising a remotely operating controlling device which is constructed to remotely control said recording camera to enable the latter to carry out the recording process, and/or said remotely operating controlling device is constructed to store, to exchange and to reproduce after storing photo and/or video images and/or audio messages recorded by said camera.

16. An article of clothing as defined in claim 2, wherein said camera is constructed to carry out recordings selected from the group consisting of an audio recording, a video recording, an automated photography with or without audio recording, a video recording to record over a certain time or over a number of periods, to make a plurality of photos, and combinations thereof, wherein said recording camera is constructed as a wirelessly operated recorded camera, further comprising a remotely operating controlling device which is constructed to remotely control said recording camera to enable the latter to carry out the recording process, and wherein said recording camera and/or said remotely operating control device are constructed to store, to exchange and to reproduce after storing photography and/or video and/or audio messages recorded by said recording camera.

17. An article of clothing as defined in to claim 3, wherein said camera is constructed to carry out recordings selected from the group consisting of an audio recording, a video recording, an automated photography with or without audio recording, a video recording to record over a certain time or over a number of periods, to make a plurality of photos, and combinations thereof, wherein said recording camera is constructed as a wirelessly operated recorded camera, further comprising a remotely operating controlling device which is constructed to remotely control said recording camera to enable the latter to carry out the recording process, and wherein said recording camera and/or said remotely operating control device are constructed to store, to exchange and to reproduce after storing photography and/or video and/or audio messages recorded by said recording camera.

18. An article of clothing as defined in to claim 2, wherein said camera is constructed to carry out recordings selected from the group consisting of an audio recording, a video recording, an automated photography with or without audio recording, a video recording to record over a certain time or over a number of periods, to make a plurality of photos, and combinations thereof, where said recording camera is also constructed to simultaneously carry out photography recording during video recording, wherein said recording camera is constructed as a wirelessly operated recorded camera, further comprising a remotely operating controlling device which is constructed to remotely control said recording camera to enable the latter to carry out the recording process, and wherein said recording camera and/or said remotely operating control device are constructed to store, to exchange and to reproduce after storing photography and/or video and/or audio messages recorded by said recording camera.

19. An article of clothing as defined in to claim 2, and further comprising a motion detecting element constructed to detect motion in a vicinity of the recording camera and to activate it to carry out the recording process in response to the detection of motion, wherein said camera is constructed to carry out recordings selected from the group consisting of an audio recording, a video recording, an automated photography with or without audio recording, a video recording to record over a certain time or over a number of periods, to make a plurality of photos, and combinations thereof, where said recording camera is also constructed to simultaneously carry out photography recording during video recording, wherein said recording camera is constructed as a wirelessly operated recorded camera, further comprising a remotely operating controlling device which is constructed to remotely control said recording camera to enable the latter to carry out the recording process, and wherein said recording camera and/or said remotely operating control device are constructed to store, to exchange and to reproduce after storing photography and/or video and/or audio messages recorded by said recording camera.

20. An article of clothing as defined in claim 3, and further comprising a motion detecting element constructed to detect motion in a vicinity of the recording camera and to activate it to carry out the recording process in response to the detection of motion, wherein said camera is constructed to carry out recordings selected from the group consisting of an audio recording, a video recording, an automated photography with or without audio recording, a video recording to record over a certain time or over a number of periods, to make a plurality of photos, and combinations thereof, where said recording camera is also constructed to simultaneously carry out photography recording during video recording, wherein said recording camera is constructed as a wirelessly operated recorded camera, further comprising a remotely operating controlling device which is constructed to remotely control said recording camera to enable the latter to carry out the recording process, and wherein said recording camera and/or said remotely operating control device are constructed to store, to exchange and to reproduce after storing photography and/or video and/or audio messages recorded by said recording camera.
